(19) United States
(12) Patent Application Publication
(10) Pub. No.: US 2018/0132146 A1
(43) Pub. Date: May 10, 2018

(54) SINGLE CELL POINT-TO-MULTICAST SERVICE CONTINUITY USING LTE + LTE

(71) Applicant: QUALCOMM Incorporated, San Diego, CA (US)

(72) Inventors: Kuo-Chun LEE, San Diego, CA (US); Sivaramakrishna VEEREPALLI, San Diego, CA (US); Reza SHAHIDI, San Diego, CA (US); Qingxin CHEN, San Diego, CA (US); Qiang JIANG, San Diego, CA (US); YuHung KAO, San Diego, CA (US); Ankit MEHROTRA, San Diego, CA (US)

(21) Appl. No.: 15/345,057

(22) Filed: Nov. 7, 2016

(51) Int. Cl. H04W 36/02; H04W 36/00; H04W 72/00

(52) U.S. Cl. CPC H04W 36/026; H04W 72/005; H04W 36/0072

(57) ABSTRACT

A method for single cell point-to-multicast service continuity on a multi-subscriber identity module (SIM) mobile communication device includes: receiving single cell point-to-multicast (SC-PTM) data from a first cell on a first subscription; activating a second subscription; receiving the SC-PTM data from the first cell on the second subscription; performing a handover or reselection from the first cell to a second cell on the first subscription; receiving the SC-PTM data from the second cell on the first subscription; and deactivating the second subscription.

### BACKGROUND

Single Cell Point-to-Multicast (SC-PTM) is an alternative to Multimedia Broadcast Single-Frequency Network (MBSFN) based enhanced Multimedia Broadcast Multicast Service (eMBMS) broadcast. SC-PTM can also be used in Mission Critical Push-to-Talk (MCPTT), Internet of Things (IoT), and Vehicle-to-everything (V2X). In SC-PTM, one cell can use the Physical Downlink Shared Channel (PDSCH) to send broadcast data and control information to a group of mobile communication devices: data of an eMBMS service are sent on the PDSCH using a group-specific Radio Network Temporary Identifier (G-RNTI), and control information is sent on the PDSCH using an SC-PTM Radio Network Temporary Identifier (SC-RNTI). Unlike MBSFN based eMBMS, multiple SC-PTM cells can broadcast the same eMBMS service without any coordination, e.g., with different subframe and frequency resource blocks and modulation and coding scheme (MCS).

To receive an SC-PTM transmission, a mobile communication device will receive three items: System Information Block 20 (SIB20), Single Cell Multicast Control Channel (SC-MCCH), and Single Cell Multicast Traffic Channel (SC-MTCH). SIB20 indicates how to receive the SC-MCCH. The SC-MCCH indicates available Temporary Mobile Group Identities (TMGIs) and how to receive the SC-MTCH. The SC-MTCH can be used to transfer data of one eMBMS service. The SCPTMConfiguration message indicates ongoing MBMS sessions and, in addition, information on which each session may be scheduled. The SCPTMConfiguration message is carried by the SC-MCCH.

The evolved Node B (eNB) can indicate whether each of the neighbor cells broadcasts the same eMBMS service or not. The SCPTMConfiguration message may include a neighbor cell list, scptm-NeighbourCellList, for potential neighbors providing a same Temporary Mobile Group Identity, (TMGI), which is a unique identifier used to identify a MBMS session within a PLMN. A neighbor cell is signaled with the parameter physCellId, which is a physical cell ID, and optional parameter carrierFreq, which is a carrier frequency ID. Under TMGI, an 8-bit map, sc-mtch-NeighbourCellList, is included, where the first bit is set to 1 if the same service is provided on the SC-MTCH in the first cell in scptm-NeighbourCellList; otherwise, the first bit is set to 0. The remaining bits corresponding to the other cells in scptm-NeighbourCellList are set accordingly.

A mobile communication device may be handed-over or reselected to a target neighbor cell and the same eMBMS service may be broadcasted by the target cell. However, during the handover or cell reselection process, the mobile communication device stops eMBMS reception and acquires SIB20 and the SC-MCCH at the target cell before eMBMS can resume. Thus, during the transition process, the eMBMS service is interrupted.

FIG. 4 is a sequence diagram illustrating a messaging process 400 during a conventional handover. At 422, a SC-MTCH is sent to the mobile communication device 410 by cell 1 420. At 424 a RRCConnectionReconfiguration message is sent from cell 1 420 to the mobile communication device 410. The RRCConnectionReconfiguration message is used to modify an RRC connection. Such modifications include performing handovers. As illustrated in FIG. 4, after handover is initiated between a mobile communication device 410, a serving cell 420, and a target neighbor cell 430, the eMBMS service is stopped 440.

To assist the mobile communication device 410 with searching Cell 2 430, Cell 2 430 sends mobile communication device 410 three signals 442 on the downlink: the Primary Synchronization Signal (PSS), the Secondary Synchronization Signal (SSS), and the physical broadcast channel (PBCH). The PBCH is used to broadcast a limited number of parameters such as the master information block (MIB). The next step is the Random Access Procedure (RACH) 444 in which the mobile communication device 410 requests access to Cell 2 430.

Subsequently, an RRCConnectionReconfigurationComplete message 446 is sent from the mobile communication device 410 to cell 2 420. At 448 SIB1 is then sent to the mobile communication device 410. The mobile communication device 410 then acquires SIB20 450, the SC-MCCH 460, and the SC-MTCH 470 from the target neighbor cell 430 after which time the eMBMS service resumes 480 on the mobile communication device 410.

The eMBMS service may be interrupted for 0.5-1 second which can affect user perception of video streaming. For example, if handover or cell reselection has a mean period of 30 seconds, an interruption duration of one second, and a video segment duration of one second, then video segment loss rate can increase by 2/30=6.7%.

### SUMMARY

Apparatuses and methods for providing single cell point-to-multicast service continuity are provided.

According to various aspects there is provided a method for single cell point-to-multicast service continuity on a multi-subscriber identity module (SIM) mobile communication device. In some aspects, the method may include: receiving single cell point-to-multicast (SC-PTM) data from a first cell on a first subscription; activating a second subscription; receiving the SC-PTM data from the first cell on the second subscription; performing a handover or reselection from the first cell to a second cell on the first subscription; receiving the SC-PTM data from the second cell on the first subscription; and deactivating the second subscription

According to various aspects there is provided a multi-subscriber identity module (SIM) mobile communication device. In some aspects, the multi-SIM mobile communication device may include: a communication unit; and a control unit operably coupled to the communication unit.

The control unit may be configured to: control the communication unit to receive single cell point-to-multicast (SC-PTM) data from a first cell on a first subscription; activate a second subscription; control the communication unit to receive the SC-PTM data from the first cell on the second subscription; perform a handover or reselection from the first cell to a second cell on the first subscription; control the communication unit to receive the SC-PTM data from the second cell on the first subscription; and deactivate the second subscription.

According to various aspects there is provided a non-transitory computer readable medium. In some aspects, the non-transitory computer readable medium may include instructions for causing one or more processors to perform operations including: receiving single cell point-to-multicast (SC-PTM) data from a first cell on a first subscription; activating a second subscription; receiving the SC-PTM data from the first cell on the second subscription; performing a handover or reselection from the first cell to a second cell on the first subscription; receiving the SC-PTM data from the second cell on the first subscription; and deactivating the second subscription

According to various aspects there is provided a multi-subscriber identity module (SIM) mobile communication device. In some aspects, the multi-SIM mobile communication device may include: means for receiving single cell point-to-multicast (SC-PTM) data from a first cell on a first subscription; means for activating a second subscription; means for receiving the SC-PTM data from the first cell on the second subscription; means for performing a handover or reselection from the first cell to a second cell on the first subscription; means for receiving the SC-PTM data from the second cell on the first subscription; and means for deactivating the second subscription.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device in accordance with certain aspects of the present disclosure;

FIG. 1B is a diagram illustrating a network environment in accordance with certain aspects of the present disclosure;

FIG. 2 is a sequence diagram illustrating a messaging process during handover in accordance with certain aspects of the present disclosure;

FIG. 3 is a flowchart illustrating a method for providing single cell point-to-multicast service continuity in accordance with certain aspects of the present disclosure; and

FIG. 4 is a sequence diagram illustrating a messaging process 400 during a conventional handover.

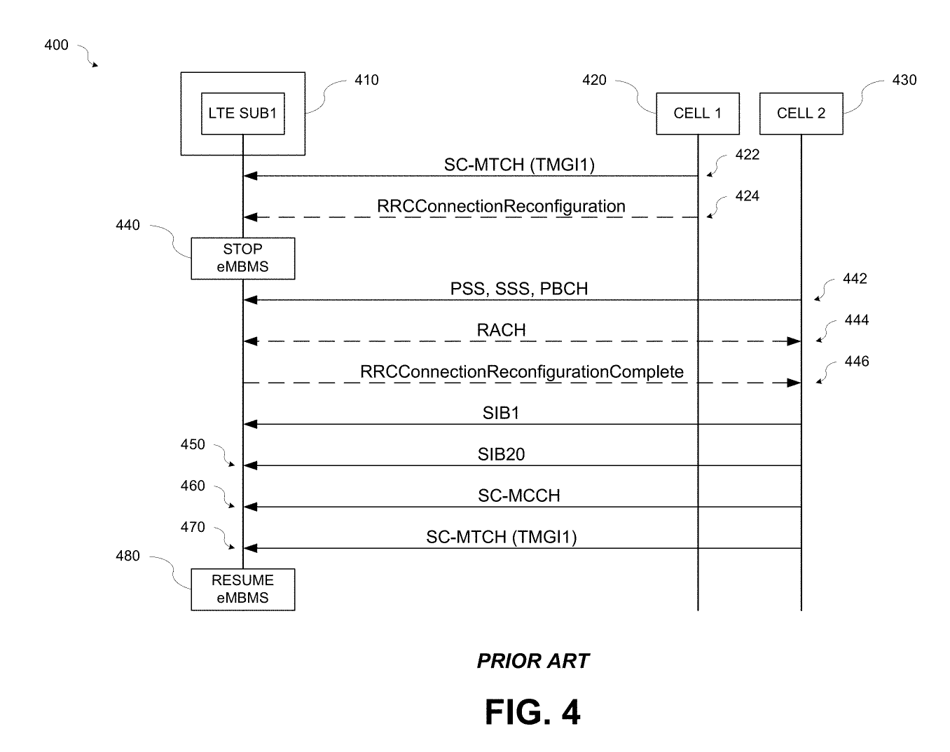

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

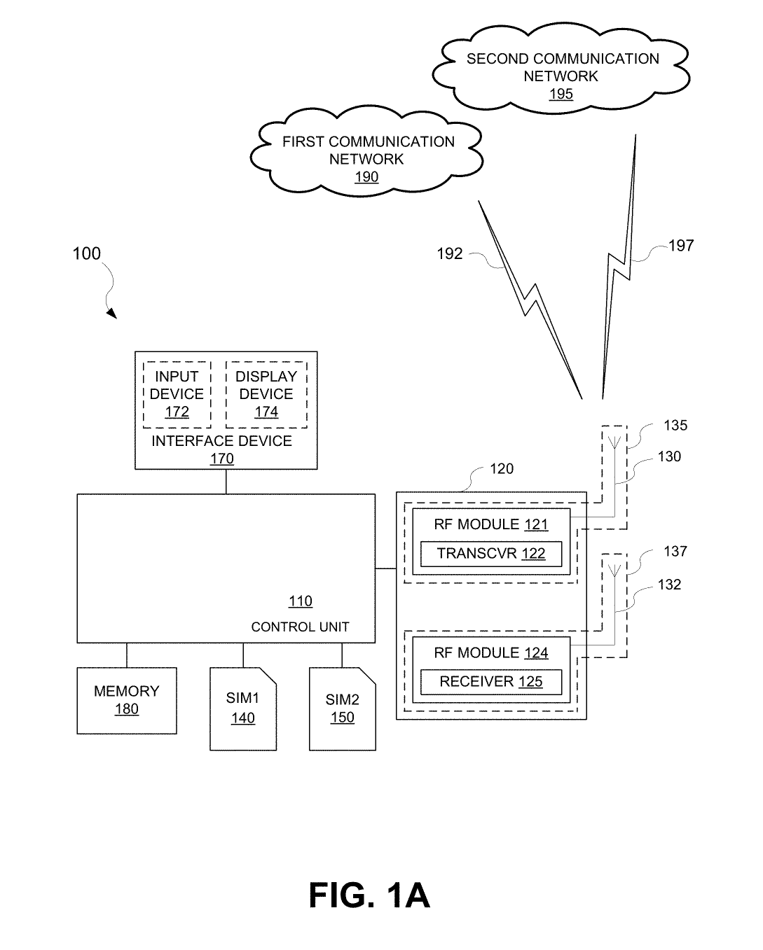

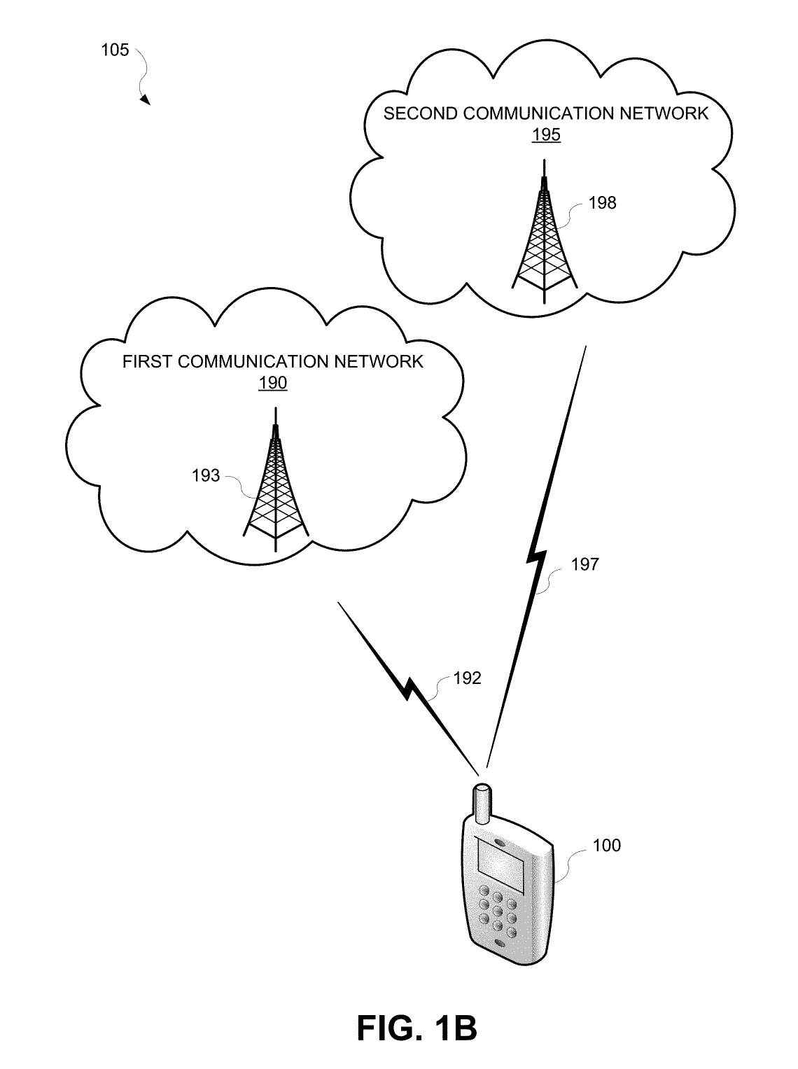

FIG. 1A is a block diagram illustrating a mobile communication device 100 according to various examples. As illustrated in FIG. 1, the mobile communication device 100 may include a control unit 110, a communication unit 120, a first antenna 130, a second antenna 132, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, a first radio frequency (RF) module 121. The first RF module 121 may include, for example, but not limited to a transceiver 122. A first RF chain 135 may include, for example, but not limited to the first antenna 130 and the first RF module 121.

The communication unit 120 may also include, for example, but not limited to, a second RF module 124. The second RF module 124 may include, for example, but not limited to a receiver 125. A second RF chain 137 may include, for example, but not limited to the second antenna 132 and the second RF module 124. Dual receive (i.e., simultaneous support of multiple RATs, for example, 5G and a legacy radio access technology (RAT) on a downlink reception end) may be supported.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first RAT, for example, but not limited to, long term evolution (LTE), on a first communication network 190 and the second SIM 155 may associate the communication unit 120 with a second subscription (Sub2) 197 associated with a second RAT), for example, but not limited to, LTE, on a second communication network 195. One of ordinary skill in the art will appreciate that other RATs may be used without departing from the scope of the present disclosure.

For convenience, the various examples are described in terms of Dual-SIM Dual-Standby (DSDS) mobile communication devices. However, one of ordinary skill in the art will appreciate that the various examples may be extended to Multi-SIM Multi-Standby (MSMS) and/or Multi-SIM Multi-Active (MSMA) mobile communication devices without departing from the scope of the present disclosure.

The first communication network 190 and the second communication network 195 may be operated by the same or different service providers, and/or may support the same or different RATs, for example, but not limited to, GSM, CDMA, wideband CDMA (WCDMA), and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

The mobile communication device 100 may reuse the LTE access stratum for the first LTE subscription (Sub1 192) and the LTE access stratum for the second LTE subscription (Sub2 197) (i.e., the dual-active functionality) to maintain the eMBMS service without interruption during handover and/or cell reselection.

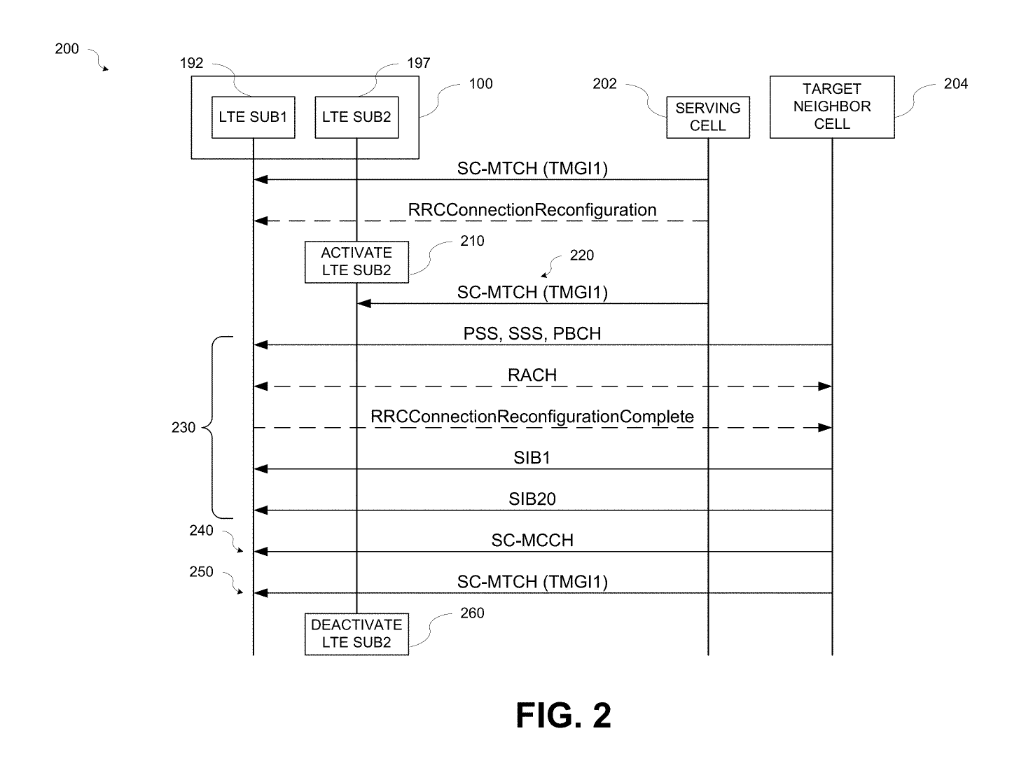

FIG. 2 is a sequence diagram illustrating a messaging process 200 during handover in accordance with certain aspects of the present disclosure. As illustrated in FIG. 2, after handover or reselection is initiated between a mobile communication device 100 on a first LTE subscription (e.g., Sub1 192), a serving cell 202, and a target neighbor cell 204, a second LTE subscription (e.g., Sub2 197) may be activated 210 and may receive SC-PTM data (e.g., the SC-MTCH for the eMBMS service) 220. The serving cell 202 and the target neighbor cell 204 may be on the same frequency and utilize the same RF baseband tuning of the mobile communication device 100. The serving cell 202 and the target neighbor cell 204 may transmit the SC-PTM data under the same TMGI. Note that unicast data may be stopped.

The mobile communication device 100 may continue to change cells and acquire the Random Access Channel (RACH), Physical Broadcast Channel (PBCH), primary synchronization signal (PSS), secondary synchronization signal (SSS), and data including SIB1 and SIB20 230, from the target neighbor cell 204 on the first LTE subscription Sub1 192. When the mobile communication device 100 starts to receive the SC-PTM (i.e., the SC-MCCH 240, and the SC-MTCH 250) from the target neighbor cell 204 on the first LTE subscription Sub1 192, the SC-PTM reception on the second LTE subscription Sub2 197 may be stopped and the second LTE subscription Sub2 197 may be deactivated 260.

The second LTE subscription Sub2 197 may only need to activate the access stratum protocol layer of the downlink path for receiving SC-PTM data, such as Layer 1 (L1), Medium Access Control (MAC) and Radio Link Control (RLC) and Internet Protocol (IP) layers. Uplink transmission, unicast data reception, signaling reception, etc., may not be activated. In addition, to configure the second LTE subscription Sub2 197, configuration of the first LTE subscription Sub1 192 for receiving SC-PTM data may transfer to the second LTE subscription Sub2 197, e.g. frame and subframe timing, SIBs, SC-MCCH, IP configuration of the eMBMS service, etc.

During the dual-active time period (i.e., while Sub1 192 and Sub2 197 are both active) the mobile communication device 100 may receive data from two links for very short time. Some duplicated data (i.e., same UDP/IP packets) may be received; however, the file delivery over unidirectional transport (FLUTE) can discard the duplicated packets.

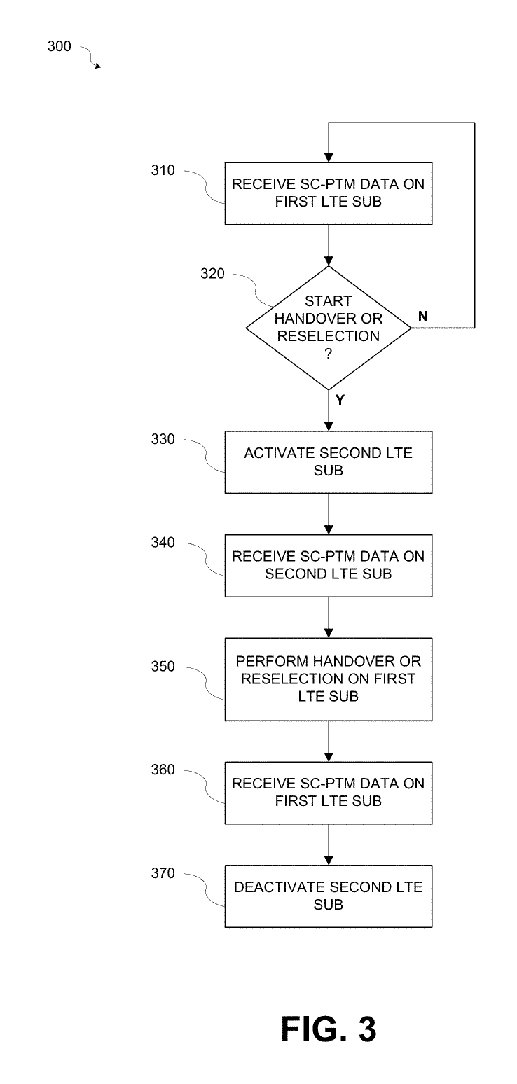

FIG. 3 is a flowchart illustrating a method 300 for providing single cell point-to-multicast service continuity in accordance with certain aspects of the present disclosure. Referring to FIG. 3, at block 310 the mobile communication device 100 may receive SC-PTM data from a serving cell (e.g., the serving cell 202) on a first LTE subscription (e.g., Sub1 192). For example, the control unit 110 may control the communication unit 120 to receive SC-PTM data from the serving cell 202 on Sub1 192 using the first RF chain 135.

At block 320, the mobile communication device 100 may determine whether handover or cell reselection should be initiated. For example, the control unit 110 may determine whether signal strength measurements for a neighbor cell are higher than the signal strength measurements for the serving cell 202. In response to determining that signal strength measurements for a neighbor cell are not higher than the signal strength measurements for the serving cell 202, the control unit 110 may determine that handover or cell reselection should not be initiated (320-N). The control unit 110 may control the communication unit 120 to continue receiving SC-PTM data from the serving cell 202 on Sub1 192.

Alternatively, the control unit 110 may determine that handover or cell reselection should be initiated (320-Y). For example, the control unit 110 may determine that signal strength measurements for a neighbor cell are higher than the signal strength measurements for the serving cell 202. In response to determining that handover or cell reselection should be initiated, at block 330 the control unit 110 may control the communication unit 120 to activate a second LTE subscription (e.g., Sub2 197). At block 340, SC-PTM data may be received on Sub2 197. For example, the control unit 110 may control the communication unit 120 to receive SC-PTM data from the serving cell 202 on Sub2 197 using the second RF chain 137.

At block 350, the mobile communication device 100 may perform handover or reselection to a neighbor cell (e.g., the target neighbor cell 204) on Sub 1 192. The serving cell 202 and the target neighbor cell 204 may transmit the SC-PTM data under the same TMGI. The control unit 110 may control the communication unit 120 to perform a handover or reselection from the serving cell 202 to the target neighbor cell 204 on Sub1 192 using the first RF chain 135 while receiving the SC-PTM data from the serving cell 202 on Sub2 197 using the second RF chain 137. The serving cell 202 and the target neighbor cell 204 may be on the same frequency and may utilize the same RF baseband tuning of the mobile communication device 100.

The control unit 110 may control the communication unit 120 to acquire the RACH, PSS, SSS, and data including SIB1 and SIB20 230, from the target neighbor cell 204 on the first LTE subscription Sub1 192 using the first RF chain 135. At block 360, when the handover or reselection on Sub1 192 is complete, the mobile communication device 100 may receive the SC-PTM data from the target neighbor cell 204 on Sub1 192 using the first RF chain 135. The control unit 110 may control the communication unit 120 to receive SC-PTM data from the target neighbor cell 204 on Sub1 192 using the first RF chain 135.

At block 370, after the mobile communication device 100 begins receiving the SC-PTM data from the target neighbor cell 204 on Sub1 192, Sub2 197 may be deactivated. For example, the control unit 110 may determine that Sub1 192 has begun to receive the SC-PTM data from the target neighbor cell 204 on the first RF chain 135 and may control the communication unit 120 to release the Sub2 197 connection to the serving cell 202 on the second RF chain 137. While Sub1 192 and Sub2 197 are both active the mobile communication device 100 may receive data from two links for very short time. Some duplicated data (i.e., same UDP/IP packets) may be received; however, the file delivery over unidirectional transport (FLUTE) can discard the duplicated packets.

The method 300 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for single cell point-to-multicast service continuity on a multi-subscriber identity module (SIM) mobile communication device, the method comprising:
receiving single cell point-to-multicast (SC-PTM) data from a first cell on a first subscription;
activating a second subscription;
receiving the SC-PTM data from the first cell on the second subscription;
performing a handover or reselection from the first cell to a second cell on the first subscription;
receiving the SC-PTM data from the second cell on the first subscription; and
deactivating the second subscription.

2. The method of claim 1, further comprising:
receiving the SC-PTM data from the first cell on the second subscription during the handover or reselection from the first cell to the second cell on the first subscription.

3. The method of claim 1, further comprising:
discarding duplicate SC-PTM data received during a time period when both the first subscription and the second subscription are receiving SC-PTM data.

4. The method of claim 1, wherein the receiving SC-PTM data from a first cell on a first subscription comprises receiving the SC-PTM data from the first cell on a first radio frequency (RF) chain.

5. The method of claim 1, wherein the receiving SC-PTM data from the first cell on a second subscription comprises receiving the SC-PTM data from the first cell on a second radio frequency (RF) chain.

6. The method of claim 1, wherein the SC-PTM data received from the first cell and the second cell are received on a same frequency.

7. The method of claim 1, wherein the deactivating the second subscription comprises deactivating the second subscription when the first subscription begins receiving the SC-PTM data from the second cell.

8. The method of claim 1, wherein the first subscription and the second subscription are long term evolution (LTE) subscriptions.

9. A multi-subscriber identity module (SIM) mobile communication device, comprising:
a communication unit; and
a control unit operably coupled to the communication unit, the control unit configured to:
control the communication unit to receive single cell point-to-multicast (SC-PTM) data from a first cell on a first subscription;
activate a second subscription;
control the communication unit to receive the SC-PTM data from the first cell on the second subscription;
perform a handover or reselection from the first cell to a second cell on the first subscription;
control the communication unit to receive the SC-PTM data from the second cell on the first subscription; and
deactivate the second subscription.

10. The multi-SIM mobile communication device of claim 9, further comprising:
wherein the control unit is further configured to control the communication unit to receive the SC-PTM data from the first cell on the second subscription during the handover or reselection from the first cell to the second cell on the first subscription.

11. The multi-SIM mobile communication device of claim 9, wherein the control unit is further configured to discard duplicate SC-PTM data received during a time period when both the first subscription and the second subscription are receiving SC-PTM data.

12. The multi-SIM mobile communication device of claim 9,
wherein the communication unit comprises a first radio frequency (RF) chain and a second RF chain, and
wherein the control unit is further configured to control the communication unit to receive the SC-PTM data from the first cell on the second RF chain during the handover or reselection from the first cell to the second cell on the first RF chain.

13. The multi-SIM mobile communication device of claim 12, wherein the first RF chain and the second RF chain receive the SC-PTM data from the first cell and the second cell, respectively, on a same frequency.

14. The multi-SIM mobile communication device of claim 12, wherein the control unit is further configured to control the communication unit to release a connection between the second RF chain and the first cell when the first RF chain begins receiving the SC-PTM data from the second cell.

15. The multi-SIM mobile communication device of claim 9, wherein the first subscription and the second subscription are long term evolution (LTE) subscriptions.

16. A non-transitory computer readable medium having stored thereon instructions for causing one or more processors to perform operations comprising:
receiving single cell point-to-multicast (SC-PTM) data from a first cell on a first subscription;
activating a second subscription;
receiving the SC-PTM data from the first cell on the second subscription;
performing a handover or reselection from the first cell to a second cell on the first subscription;
receiving the SC-PTM data from the second cell on the first subscription; and
deactivating the second subscription.

17. The non-transitory computer readable medium having stored therein instructions as defined in claim 16, the instructions further including:
receiving the SC-PTM data from the first cell on the second subscription during the handover or reselection from the first cell to the second cell on the first subscription.

18. The non-transitory computer readable medium having stored therein instructions as defined in claim 16, the instructions further including:
discarding duplicate SC-PTM data received during a time period when both the first subscription and the second subscription are receiving SC-PTM data.

19. The non-transitory computer readable medium having stored therein instructions as defined in claim 16, the instructions further including:
receiving the SC-PTM data from the first cell on a first radio frequency (RF) chain.

20. The non-transitory computer readable medium having stored therein instructions as defined in claim 16, the instructions further including:
receiving the SC-PTM data from the first cell on a second radio frequency (RF) chain.

21. The non-transitory computer readable medium having stored therein instructions as defined in claim 16, the instructions further including:
receiving the SC-PTM data from the first cell and the second cell on a same frequency.

22. The non-transitory computer readable medium having stored therein instructions as defined in claim 16, the instructions further including:
deactivating the second subscription when the first subscription begins receiving the SC-PTM data from the second cell.

23. The non-transitory computer readable medium having stored therein instructions as defined in claim 16, wherein the first subscription and the second subscription are long term evolution (LTE) subscriptions.

24. A multi-subscriber identity module (SIM) mobile communication device, comprising:
means for receiving single cell point-to-multicast (SC-PTM) data from a first cell on a first subscription;
means for activating a second subscription;
means for receiving the SC-PTM data from the first cell on the second subscription;
means for performing a handover or reselection from the first cell to a second cell on the first subscription;
means for receiving the SC-PTM data from the second cell on the first subscription; and
means for deactivating the second subscription.

25. The multi-SIM mobile communication device of claim 24, further comprising:
means for receiving the SC-PTM data from the first cell on the second subscription during the handover or reselection from the first cell to the second cell on the first subscription.

26. The multi-SIM mobile communication device of claim 24, further comprising:
means for discarding duplicate SC-PTM data received during a time period when both the first subscription and the second subscription are receiving SC-PTM data.

27. The multi-SIM mobile communication device of claim 24, further comprising:
means for receiving the SC-PTM data from the first cell on a first radio frequency (RF) chain.

28. The multi-SIM mobile communication device of claim 24, further comprising:
means for receiving the SC-PTM data from the first cell on a second radio frequency (RF) chain.

29. The multi-SIM mobile communication device of claim 24, wherein the SC-PTM data received from the first cell and the second cell are received on a same frequency.

30. The multi-SIM mobile communication device of claim 24, further comprising:
means for deactivating the second subscription when the first subscription begins receiving the SC-PTM data from the second cell.

31. The multi-SIM mobile communication device of claim 24, wherein the first subscription and the second subscription are long term evolution (LTE) subscriptions.
